(19) United States
(12) Patent Application Publication
(10) Pub. No.: US 2017/0150394 A1
(43) Pub. Date: May 25, 2017

(54) Radio Congestion Control Method and Device

(71) Applicant: Huawei Technologies Co., Ltd., Shenzhen (CN)

(72) Inventors: Yuqun Fan, Shenzhen (CN); Lei Zhou, Shenzhen (CN)

(21) Appl. No.: 15/426,337

(22) Filed: Feb. 7, 2017

Related U.S. Application Data
(63) Continuation of application No. PCT/CN2015/076087, filed on Apr. 8, 2015.

(30) Foreign Application Priority Data
Oct. 31, 2014 (CN) 201410616678.2

(51) Int. Cl. H04W 28/02; H04L 12/851; H04L 12/813

(52) U.S. Cl. CPC H04W 28/0268; H04L 47/20; H04L 47/2441; H04W 28/0236

(57) ABSTRACT

A method includes: obtaining, by a PCRF, actual rates of service flows processed by multiple user equipment; determining, by the PCRF, a congestion relief policy according to the obtained actual rates of the service flows processed by the multiple user equipment; and sending, by the PCRF, the congestion relief policy to a service flow pass-through node, so that the service flow pass-through node executes the congestion relief policy. It is determined, according to obtained actual rates of service flows processed by different user equipment, that an actual rate of a service flow processed by a user equipment is limited, so as to increase an actual rate of a service flow processed by another user equipment. This effectively relieves system congestion and improves user experience during congestion.

### CROSS-REFERENCE TO RELATED APPLICATIONS

This application is a continuation application of international patent application number PCT/CN2015/076087 filed on Apr. 8, 2015, which claims priority to Chinese patent application number 201410616678.2 filed on Oct. 31, 2014, which are incorporated by reference.

### TECHNICAL FIELD

The present application relates to the field of wireless communications technologies, and in particular, to a radio congestion control method and device.

### BACKGROUND

In a radio Long Term Evolution (LTE) network, a Policy and Charging Control (PCC) architecture is used to implement a policy determining and charging function for user data transmission.

Further, as a main function entity for generating a control policy, a policy and charging rule function (PCRF) receives application layer information from an application function (AF), user subscription information from a subscription profile repository (SPR), and IP-connectivity access network (IP-CAN) information from a policy and charging enforcement function (PCEF), obtains, according to the received application layer information, user subscription information, and IP-CAN information, a control policy based on a service data flow (SDF), and sends the obtained control policy to a data pass-through node, such as the PCEF or an evolved NodeB (eNodeB), for execution.

As a last node through which data flows to a user equipment (UE), the eNodeB transmits data to the UE according to the control policy and a scheduling policy that are sent by the PCRF. However, in an actual data transmission process, for many reasons such as a UE channel condition, a quantity of users accessing to a same cell, and a user service data volume, data sent to a user is likely to congest at the eNodeB, thereby causing a problem such as a relatively great delay of user data transmission or data loss.

### SUMMARY

In view of this, embodiments of the present application provide a radio congestion control method and device, used for determining a congestion relief policy to relieve system congestion.

According to a first aspect of the present application, a radio congestion control method is provided, including obtaining, by a PCRF, actual rates of service flows processed by multiple UEs, determining, by the PCRF, a congestion relief policy according to the obtained actual rates of the service flows processed by the multiple UEs, where the congestion relief policy is used to limit an actual rate of a service flow processed by a UE in the multiple UEs, and sending, by the PCRF, the congestion relief policy to a service flow pass-through node.

With reference to the first aspect of the present application, in a first possible implementation manner, the method further includes obtaining, by the PCRF, subscription information of the multiple UEs, or obtaining service flow information of the service flows processed by the multiple UEs, and determining, by the PCRF, a congestion relief policy according to the obtained actual rates of the service flows processed by the multiple UEs includes determining, by the PCRF according to the obtained actual rates of the service flows processed by the multiple UEs and the obtained subscription information of the multiple UEs or obtained application layer information of the service flows processed by the multiple UEs, the service flow whose actual rate is limited and a target rate of the limited service flow, and determining, by the PCRF, the congestion relief policy according to the service flow whose actual rate is limited and the target rate of the limited service flow, where the target rate of the limited service flow includes a maximum bit rate of the limited service flow.

With reference to the first possible implementation manner of the first aspect of the present application, in a second possible implementation manner, the method further includes obtaining, by the PCRF, channel qualities measured by the multiple UEs, and determining, by the PCRF, a congestion relief policy according to the obtained actual rates of the service flows processed by the multiple UEs includes determining, by the PCRF according to the obtained actual rates of the service flows processed by the multiple UEs, the obtained channel qualities measured by the multiple UEs, and the obtained subscription information of the multiple UEs or the obtained application layer information of the service flows processed by the multiple UEs, the service flow whose actual rate is limited and the target rate of the limited service flow, and determining, by the PCRF, the congestion relief policy according to the service flow whose actual rate is limited and the target rate of the limited service flow.

With reference to the first aspect of the present application, the first possible implementation manner of the first aspect of the present application, or the second possible implementation manner of the first aspect of the present application, in a third possible implementation manner, the service flow whose actual rate is limited meets one or more of the following conditions. The actual rate of the service flow is greater than a specified expected rate, according to a subscriber class included in the obtained subscription information of the multiple UEs, the service flow whose actual rate is limited belongs to a service flow processed by a UE whose subscriber class is lower than a specified first threshold class, or according to a service processing class included in the obtained application layer information of the service flows processed by the multiple UEs, the service flow whose actual rate is limited belongs to a service flow whose service processing class is lower than a specified second threshold class.

With reference to the first aspect of the present application, the first possible implementation manner of the first aspect of the present application, the second possible implementation manner of the first aspect of the present application, or the third possible implementation manner of the first aspect of the present application, in a fourth possible implementation manner, the obtaining, by a PCRF, actual rates of service flows processed by multiple UEs includes receiving, by the PCRF, radio access network (RAN) user plane congestion information (RUCI) sent by a radio congestion awareness function (RCAF) or the service flow pass-through node, where the RUCI includes the actual rates of the service flows processed by the multiple UEs, and obtaining, by the PCRF from the received RUCI, the actual rates of the service flows processed by the multiple UEs.

With reference to the fourth possible implementation manner of the first aspect of the present application, in a fifth possible implementation manner, the service flow pass-through node includes at least one or more of a PCEF, a traffic detection function (TDF), or an eNodeB.

According to a second aspect of the present application, a radio congestion control method is provided, including sending, by a service flow pass-through node, actual rates of service flows processed by multiple UEs to a PCRF, receiving, by the service flow pass-through node, a congestion relief policy sent by the PCRF, where the congestion relief policy is determined by the PCRF according to the actual rates of the service flows processed by the multiple UEs, and the congestion relief policy is used to limit an actual rate of a service flow of a UE in the multiple UEs, and controlling, by the service flow pass-through node, current congestion according to the received congestion relief policy.

With reference to the second aspect of the present application, in a first possible implementation manner, the sending, by a service flow pass-through node, actual rates of service flows processed by multiple UEs to a PCRF includes sending, by the service flow pass-through node, RUCI to the PCRF, where the RUCI includes the actual rates of the service flows processed by the multiple UEs.

With reference to the second aspect of the present application, or the first possible implementation manner of the second aspect of the present application, in a second possible implementation manner, the sending, by a service flow pass-through node, actual rates of service flows processed by multiple UEs to a PCRF includes collecting, by the service flow pass-through node, statistics on actual rates of the service flows processed by the multiple UEs within a specified time length, and calculating an average rate of a service flow processed by each UE within the specified time length, and triggering the service flow pass-through node to send the actual rates of the service flows processed by the multiple UEs to the PCRF when a calculated average rate of at least one service flow is less than a specified rate threshold.

With reference to the second aspect of the present application, the first possible implementation manner of the second aspect of the present application, or the second possible implementation manner of the second aspect of the present application, in a third possible implementation manner, the congestion relief policy includes the service flow whose actual rate is limited and a target rate of the service flow whose actual rate is limited, and controlling, by the service flow pass-through node, current congestion according to the received congestion relief policy includes reducing for the UE processing the service flow whose actual rate is limited, by the service flow pass-through node according to the target rate that is of the service flow whose actual rate is limited and included in the congestion relief policy, the actual rate of the limited service flow processed by the UE.

According to a third aspect of the present application, a radio congestion control device is provided, including an obtaining module configured to obtain actual rates of service flows processed by multiple UEs, a determining module configured to determine a congestion relief policy according to the obtained actual rates of the service flows processed by the multiple UEs, where the congestion relief policy is used to limit an actual rate of a service flow processed by a UE in the multiple UEs, and a control module configured to send the congestion relief policy to a service flow pass-through node.

With reference to the third aspect of the present application, in a first possible implementation manner, the obtaining module is further configured to obtain subscription information of the multiple UEs, or obtain service flow information of the service flows processed by the multiple UEs, and the determining module is configured to determine, according to the obtained actual rates of the service flows processed by the multiple UEs and the obtained subscription information of the multiple UEs or obtained application layer information of the service flows processed by the multiple UEs, the service flow whose actual rate is limited and a target rate of the limited service flow, and determine the congestion relief policy according to the service flow whose actual rate is limited and the target rate of the limited service flow, where the target rate of the limited service flow includes a maximum bit rate of the limited service flow.

With reference to the first possible implementation manner of the third aspect of the present application, in a second possible implementation manner, the obtaining module is further configured to obtain channel qualities measured by the multiple UEs, and the determining module is configured to determine, according to the obtained actual rates of the service flows processed by the multiple UEs, the obtained channel qualities measured by the multiple UEs, and the obtained subscription information of the multiple UEs or the obtained application layer information of the service flows processed by the multiple UEs, the service flow whose actual rate is limited and the target rate of the limited service flow, and determine the congestion relief policy according to the service flow whose actual rate is limited and the target rate of the limited service flow.

With reference to the third aspect of the present application, the first possible implementation manner of the third aspect of the present application, or the second possible implementation manner of the third aspect of the present application, in a third possible implementation manner, the service flow whose actual rate is limited meets one or more of the following conditions. The actual rate of the service flow is greater than a specified expected rate, according to a subscriber class included in the obtained subscription information of the multiple UEs, the service flow whose actual rate is limited belongs to a service flow processed by a UE whose subscriber class is lower than a specified first threshold class, or according to a service processing class included in the obtained application layer information of the service flows processed by the multiple UEs, the service flow whose actual rate is limited belongs to a service flow whose service processing class is lower than a specified second threshold class.

With reference to the third aspect of the present application, the first possible implementation manner of the third aspect of the present application, the second possible implementation manner of the third aspect of the present application, or the third possible implementation manner of the third aspect of the present application, in a fourth possible implementation manner, the obtaining module is configured to receive RUCI sent by a RCAF or the service flow pass-through node, where the RUCI includes the actual rates of the service flows processed by the multiple UEs, and obtain, from the received RUCI, the actual rates of the service flows processed by the multiple UEs.

With reference to the fourth possible implementation manner of the third aspect of the present application, in a fifth possible implementation manner, the service flow pass-through node includes at least one or more of a PCEF, a TDF, or an eNodeB.

According to a fourth aspect of the present application, a radio congestion control device is provided, including a sending module configured to send actual rates of service flows processed by multiple UEs to a PCRF, a receiving module configured to receive a congestion relief policy sent by the PCRF, where the congestion relief policy is determined by the PCRF according to the actual rates of the service flows processed by the multiple UEs, and the congestion relief policy is used to limit an actual rate of a service flow of a UE in the multiple UEs, and a congestion control module configured to control current congestion according to the received congestion relief policy.

With reference to the fourth aspect of the present application, in a first possible implementation manner, the sending module is configured to send RUCI to the PCRF, where the RUCI includes the actual rates of the service flows processed by the multiple UEs.

With reference to the fourth aspect of the present application, or the first possible implementation manner of the fourth aspect of the present application, in a second possible implementation manner, the sending module is configured to collect statistics on actual rates of the service flows processed by the multiple UEs within a specified time length, and calculate an average rate of a service flow processed by each UE within the specified time length, and triggered to send the actual rates of the service flows processed by the multiple UEs to the PCRF when a calculated average rate of at least one service flow is less than a specified rate threshold.

With reference to the fourth aspect of the present application, the first possible implementation manner of the fourth aspect of the present application, or the second possible implementation manner of the fourth aspect of the present application, in a third possible implementation manner, the congestion relief policy includes the service flow whose actual rate is limited and a target rate of the service flow whose actual rate is limited, and the congestion control module is configured to reduce for the UE processing the service flow whose actual rate is limited, according to the target rate that is of the service flow whose actual rate is limited and included in the congestion relief policy, the actual rate of the limited service flow processed by the UE.

The present application brings the following beneficial effects.

In the embodiments of the present application, a PCRF obtains actual rates of service flows processed by multiple UEs. The PCRF determines a congestion relief policy according to the obtained actual rates of the service flows processed by the multiple UEs. The congestion relief policy is used to limit an actual rate of a service flow processed by a UE in the multiple UEs. The PCRF sends the congestion relief policy to a service flow pass-through node such that the service flow pass-through node executes the congestion relief policy. In the embodiments of the present application, it is determined, according to obtained actual rates of service flows processed by different UE, that an actual rate of a service flow processed by a UE is limited in order to increase an actual rate of a service flow processed by another UE. This effectively relieves system congestion and improves user experience during congestion.

### BRIEF DESCRIPTION OF DRAWINGS

To describe the technical solutions in the embodiments of the present application more clearly, the following briefly describes the accompanying drawings required for describing the embodiments. The accompanying drawings in the following description show merely some embodiments of the present application, and a person of ordinary skill in the art may still derive other drawings from these accompanying drawings without creative efforts.

FIG. 1 is a schematic flowchart of a radio congestion control method according to Embodiment 1 of the present application;

FIG. 2 is a schematic flowchart of a radio congestion control method according to Embodiment 2 of the present application;

FIG. 3 is a schematic flowchart of a radio congestion control method according to Embodiment 3 of the present application;

FIG. 4 is a schematic flowchart of a radio congestion control method according to Embodiment 4 of the present application;

FIG. 5 is a schematic structural diagram of a radio congestion control device according to Embodiment 5 of the present application;

FIG. 6 is a schematic structural diagram of a radio congestion control device according to Embodiment 6 of the present application;

FIG. 7 is a schematic structural diagram of a radio congestion control device according to Embodiment 7 of the present application; and

FIG. 8 is a schematic structural diagram of a radio congestion control device according to Embodiment 8 of the present application.

### DESCRIPTION OF EMBODIMENTS

To achieve an objective of the present application, embodiments of the present application provide a radio congestion control method and device. A PCRF obtains actual rates of service flows processed by multiple UEs. The PCRF determines a congestion relief policy according to the obtained actual rates of the service flows processed by the multiple UEs.

The congestion relief policy is used to limit an actual rate of a service flow processed by a UE in the multiple UEs. The PCRF sends the congestion relief policy to a service flow pass-through node such that the service flow pass-through node executes the congestion relief policy.

In the embodiments of the present application, it is determined, according to obtained actual rates of service flows processed by different UE, that an actual rate of a service flow processed by a UE is limited in order to increase an actual rate of a service flow processed by another UE. This effectively relieves system congestion and improves user experience during congestion.

It should be noted that to relieve a system congestion problem, a RCAF and a new interface Np may be introduced to a PCC architecture.

The Np interface is configured to transmit RUCI between the RCAF and the PCRF.

The following further describes the embodiments of the present application in detail with reference to specification drawings. The described embodiments are merely some but not all of the embodiments of the present application. All other embodiments obtained by a person of ordinary skill in the art based on the embodiments of the present application without creative efforts shall fall within the protection scope of the present application.

### Embodiment 1

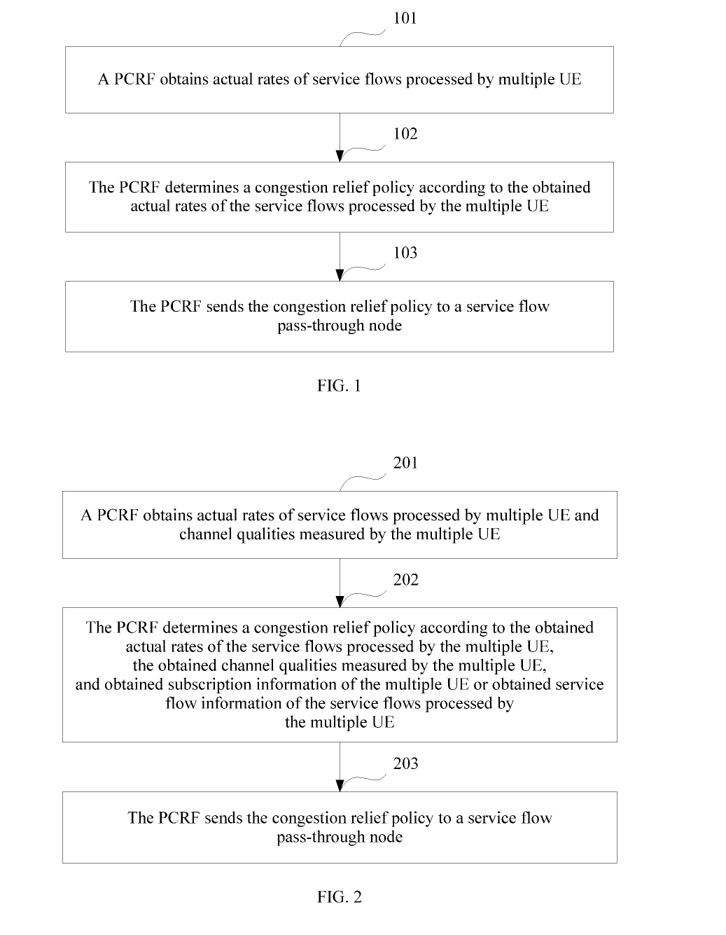

As shown in FIG. 1, FIG. 1 is a schematic flowchart of a radio congestion control method according to Embodiment 1 of the present application. The method may be described as follows.

Step 101: A PCRF obtains actual rates of service flows processed by multiple UEs.

In step 101, the multiple UEs processing the service flows whose actual rates are obtained by the PCRF meet the condition, where the multiple UEs belong to one UE cluster, and UE in the UE cluster share a same radio resource.

The UE in the UE cluster access to the same radio resource in one or more manners of Code Division Multiple Access (CDMA), Frequency Division Multiple Access (FDMA), or Time Division Multiple Access (TDMA).

For example, the multiple UEs may be multiple UEs accessing to a same serving cell or sector in the foregoing access manner, or may be UE accessing to a same service across multiple cells.

It should be noted that the actual rates of the service flows include average rates of the service flows within a specified time length.

In another embodiment of the present application, a manner for obtaining, by the PCRF, the actual rates of the service flows processed by the multiple UEs includes but is not limited to the following

The PCRF receives RUCI sent by a RCAF or a service flow pass-through node, where the RUCI includes the actual rates of the service flows processed by the multiple UEs, and the PCRF obtains, from the received RUCI, the actual rates of the service flows processed by the multiple UEs.

The PCRF obtains, using an Np interface between the PCRF and the RCAF, the RUCI sent by the RCAF.

Case 1: The RUCI that is received by the PCRF and that is sent by the RCAF or the service flow pass-through node includes an actual rate of a service flow processed by each UE within a specified time length.

In this case, the PCRF performs the following operations on the received actual rate of the service flow processed by each UE within the specified time length.

For the actual rate of the service flow processed by each UE within the specified time length, the PCRF determines whether the actual rate of the service flow processed by the UE within the specified time length is less than a specified rate threshold, and the PCRF determines that the service flow processed by the UE within the specified time length is in a congestion state and belongs to a congestion service flow if the actual rate of the service flow processed by the UE within the specified time length is less than the specified rate threshold, or the PCRF determines that the service flow processed by the UE within the specified time length is not in congestion if the actual rate of the service flow processed by the UE within the specified time length is not less than the specified rate threshold.

That is, the PCRF is triggered to execute step 102 to determine a congestion relief policy after the PCRF determines the received actual rate of the service flow by each UE within the specified time length, and if at least one actual rate in the received actual rates is less than the specified rate threshold.

It should be noted herein that in case 1, the PCRF negotiates with the RCAF, and the RCAF collects statistics on the actual rate of the service flow processed by each UE in the UE cluster, and sends, using the Np interface in real-time or at a fixed time or in a periodic manner, the RUCI that carries a statistical result to the PCRF. The PCRF herein needs to determine, according to the statistical result, whether there is a service flow processed by a UE is in congestion.

Case 2: The RUCI that is received by the PCRF and that is sent by the RCAF or the service flow pass-through node includes an actual rate of a service flow processed by a first congestion UE and an actual rate of a service flow processed by a second UE in the same UE cluster as the first UE.

It should be noted that the first congestion UE herein may refer to one UE, or may refer to multiple UEs, and this is not limited. In addition, the second UE may refer to one UE, or may refer to multiple UEs, and this is not limited.

It should be noted that if the RUCI includes the actual rates of the service flows processed by the multiple UEs, a terminal identifier of each UE further needs to be included. The terminal identifier may be an international mobile subscriber identity (IMSI), a user identifier (ID), or the like, and this is not limited herein.

In another embodiment of the present application, the first congestion UE is determined in the following manner

The RCAF collects statistics on an actual rate of the service flow processed by the first UE within a specified time length, and calculates an average rate of the service flow processed by the first UE within the specified time length. It is determined that the service flow processed by the first UE is in congestion when the average rate is less than a specified rate threshold.

It should be noted that the specified rate threshold may be preset by an operator, or may be dynamically delivered to the RCAF by the PCRF, and a specification manner is not limited herein.

Further, the RCAF collects actual rates of service flows of different UE, and the actual rates of the service flows herein may come from a RAN operations, administration and maintenance system (OAM), or may come from a node (such as an eNodeB) of a RAN.

For each UE, the RCAF calculates an average rate of a service flow processed by the UE within a specified time length, and compares the average rate with a specified rate threshold (or an expected service flow transmission rate), and it indicates that the service flow processed by the UE is in congestion if the average rate is less than the specified rate threshold, or it indicates that the service flow processed by the UE is not in congestion if the average rate is not less than the specified rate threshold.

Once the RCAF determines that a service flow processed by a UE is in congestion, when the RCAF determines that the service flow processed by the first UE is in congestion, the RCAF determines the second UE in the same UE cluster as the first UE, and is triggered to send the RUCI to the PCRF using the Np interface.

The RUCI herein includes the actual rate of the service flow processed by the first congestion UE and the actual rate of the service flow processed by the second UE in the same UE cluster as the first UE.

For example, the RCAF obtains, from a mobility management entity (MME), the second UE accessing to the same cell as the first congestion UE, and obtains the actual rate of the service flow processed by the obtained second UE.

It should be noted that in case 1 and case 2, a service flow processed by a UE may be all service flows processed by the UE, or may be some service flows processed by the UE, and this is not limited herein.

The some service flows processed by the UE should include at least one or more of the following service flows.

A congestion service flow;

A service flow whose service processing class is higher than a specified threshold;

A service flow preset by an operator or specified by the PCRF; or

A service flow whose actual rate is greater than a specified threshold.

The specified threshold may be preset by an operator or specified by the PCRF.

It should be noted that, in the service flows processed by the UE, the multiple service flows of the same service type may be processed as one service flow if a sum of actual rates of multiple service flows of a same service type is greater than a threshold.

It should be noted that an actual rate of a service flow herein may refer to an actual rate of the service flow at an application layer, or may refer to an actual rate at another protocol layer, such as a rate at a media access control (MAC) layer, and a type of rate indicated by the actual rate of the service flow is not limited herein. To obtain actual rates of service flows of different UE is to obtain actual rates of service flows of different UE at a same layer (for example, all the rates are at the application layer or at another-protocol layer).

In case 1 and case 2, a manner for sending the RUCI to the PCRF by the RCAF using the Np interface includes but is not limited to the following.

Manner 1: The RCAF generates one piece of RUCI using the obtained actual rates of the service flows processed by the multiple UEs, and sends the RUCI to the PCRF, that is, the RUCI received by the PCRF includes the actual transmission rates of the service flows processed by the multiple UEs.

Manner 2: The RCAF generates one piece of RUCI each time the RCAF obtains an actual rate of a service flow processed by each UE, and sends the RUCI to the PCRF, that is, the PCRF receives multiple pieces of RUCI, and each piece of RUCI includes an actual rate of a service flow processed by one UE.

It should be noted that a specific manner for sending the RUCI is not limited in this embodiment.

The entire RUCI may be sent together, or may be split into multiple pieces of RUCI in any manner and then sent.

In case 1 and case 2, a form for sending the RUCI to the PCRF by the RCAF using the Np interface includes but is not limited to the following

The RUCI sent to the PCRF by the RCAF using the Np interface may be carried in a message in a Diameter protocol, and include a trigger manner and all SDFs of all UE.

All the SDFs of all the UE include all SDFs of each UE. All the SDFs of each UE include a UE identifier and each SDF. Each SDF includes an SDF identifier and a rate value of the SDF.

For example:

[Event-Trigger]: indicating a trigger manner for sending RUCI information;

[Data-Rate-Description]: an audio video profile (AVP) combination, including rate description of all SDF of all UE;

[UE-Rate-Description]: an AVP combination, including rate description of all SDFs of the UE;

[UE-ID]: an identifier of the UE, usually an IMSI value;

[Flow-Rate-Description]: an AVP combination, including information about the SDF;

[Flow-Description]: an identifier of the SDF; and

[Flow-Data-Rate]: a rate value of the SDF.

It should be noted that the trigger manner that is indicated by the Event-Trigger and that is for reporting the RUCI by the RCAF to the PCRF may be a time-trigger manner, and for example, a time condition is preset on the RCAF, or may be an event-trigger manner, and for example, when the RCAF detects that a service flow processed by a UE is in congestion, sending the RUCI is triggered, or sending the RUCI is triggered when the PCRF requires the RCAF to report the RUCI.

Optionally, as shown in Table 1, Table 1 is a schematic structural diagram of a format of RUCI sent by the RCAF.

TABLE 1

| | Service flow | Service flow | | Service flow |
|---|---|---|---|---|
| | identifier 1 | identifier 2 | . . . | identifier n |
| First UE | Actual rate 11 | Actual rate 12 | . . . | Actual rate n1 |
| Second UE | Actual rate 21 | Actual rate 22 | . . . | Actual rate n2 |
| . . . | . . . | . . . | . . . | . . . |
| N^{th} UE | Actual rate n1 | Actual rate n2 | . . . | Actual rate nn |

It should be noted that if n service flows are processed by the first UE, the RUCI sent by the RCAF may include actual rates of the n service flows processed by the first UE, or may include an actual rate of a service flow in the n service flows processed by the first UE.

Optionally, the method further includes obtaining, by the PCRF, subscription information of the multiple UEs, or obtaining service flow information of the service flows processed by the multiple UEs.

The PCRF obtains the subscription information of the UE from an SPR, and obtains, from an AF, the service flow information of the service flow processed by the UE.

Step 102: The PCRF determines a congestion relief policy according to the obtained actual rates of the service flows processed by the multiple UEs.

The congestion relief policy is used to limit an actual rate of a service flow processed by a UE in the multiple UEs.

In step 102, to relieve system congestion, a radio resource needs to be coordinated between service flows processed by one or more UE, and an actual rate of a service flow is limited in order to increase an actual rate of another service flow.

The PCRF determines, according to the obtained actual rates of the service flows processed by the multiple UEs and the obtained subscription information of the multiple UEs or obtained application layer information of the service flows processed by the multiple UEs, the service flow whose actual rate is limited and a target rate of the limited service flow, and the PCRF determines the congestion relief policy according to the service flow whose actual rate is limited and the target rate of the limited service flow.

The target rate of the limited service flow includes a maximum bit rate of the limited service flow.

The congestion relief policy includes the service flow whose actual rate is limited and the target rate of the limited service flow.

The service flow whose actual rate is limited meets one or more of the following conditions. The actual rate of the service flow is greater than a specified expected rate, according to a subscriber class included in the obtained subscription information of the multiple UEs, the service flow whose actual rate is limited belongs to a service flow processed by a UE whose subscriber class is lower than a specified first threshold class, or according to a service processing class included in the obtained application layer information of the service flows processed by the multiple UEs, the service flow whose actual rate is limited belongs to a service flow whose service processing class is lower than a specified second threshold class.

The specified expected rate may be an expected rate or a maximum rate that is included in the application layer information and that is of the service flow, or may be a maximum rate that is included in the subscription information and that is allowed to be used by the UE, or may be determined according to another form. This is not limited herein.

The specified first threshold class and the specified second threshold class may be determined according to an actual requirement, or may be determined according to an actually processed service flow, and this is not limited herein either.

Subscription information of each UE or application layer information of a service flow processed by each UE may be obtained in real time by the PCRF from another network element of a PCC architecture and stored locally.

For example, the PCRF may obtain the subscription information of the UE from the SPR, and obtains, from the AF, the application layer information of the service flow processed by the UE.

A subscriber class of the UE is determined according to the obtained subscription information of the UE, and a service processing class, a minimum rate, and the like that are of the service flow processed by the UE are determined according to the obtained application layer information of the service flow.

It should be noted that a minimum rate of each service flow processed by each UE cannot always be determined from the obtained application layer information of the service flow, that is, it is possible that a minimum rate of a service flow cannot be determined.

The PCRF selects, according to the determined subscriber class of each UE, the minimum rate of each service flow, and the actual rate of the service flow processed by each UE, a service flow whose actual rate needs to be increased, and estimates a radio resource required for increasing the actual rate to the expected rate or the minimum rate.

The service flow whose actual rate needs to be increased includes at least one or more of the following service flows. A service flow whose actual rate is much less than the minimum rate, a service flow whose actual rate is much less than the minimum rate and that is processed by a UE whose subscriber class is higher than the specified first threshold class, or a service flow whose service processing class is higher than the specified second threshold class, whose actual rate is much less than the minimum rate, and that is processed by a UE whose subscriber class is higher than the specified first threshold class.

The PCRF selects, according to the determined subscriber class of each UE, the minimum rate of each service flow, and the actual rate of the service flow processed by each UE, the service flow whose actual rate needs to be limited, and calculates a target rate of the limited service flow according to the estimated required radio resource.

The service flow whose actual rate is limited meets one or more of the following conditions. The actual rate of the service flow is greater than a specified expected rate, according to a subscriber class included in the obtained subscription information of the multiple UEs, the service flow whose actual rate is limited belongs to a service flow processed by a UE whose subscriber class is lower than the specified first threshold class, or according to a service processing class included in the obtained application layer information of the service flows processed by the multiple UEs, the service flow whose actual rate is limited belongs to a service flow whose service processing class is lower than the specified second threshold class.

For example, three service flows of three UE are included in RUCI, and specific information is shown in Table 2.

TABLE 2

| | Actual rate |
|---|---|
| UE A Service flow 1 | 1.5 megabits per second (Mbps) |
| UE B Service flow 2 | 2 Mbps |
| UE C Service flow 3 | 3 Mbps |

According to subscription information of each UE, it is determined that a subscriber class of the UE A is higher than a subscriber class of the UE C. An expected rate of the service flow 1 processed by the UE A is 2 Mbps according to application layer information of the service flow, and a currently obtained actual rate of the service flow 1 processed by the UE A is 1.5 Mbps. The service flow 1 processed by the UE A may be considered in congestion, and is a determined service flow whose actual rate needs to be increased. An expected rate of the service flow 3 processed by the UE C is 1 Mbps (or unlimited) according to application layer information of the service flow, and a currently obtained actual rate of the service flow 3 processed by the UE C is 3 Mbps. The service flow 3 processed by the UE C may be considered as a determined service flow whose actual rate needs to be limited. Because the subscriber class of the UE A is higher than the subscriber class of the UE C, the PCRF decides to limit the actual rate of the service flow 3 processed by the UE C in order to increase the actual rate of the service flow 1 processed by the UE A. That is, according to an estimated radio resource required for increasing the actual rate of the service flow 1 processed by the UE A from 1.5 Mbps to 2 Mbps, a target rate (such as 1 Mbps) of the service flow 3 processed by the UE C is obtained.

It should be noted that the obtained target rate of the service flow 3 processed by the UE C may be determined according to the radio resource required by the UE A, or may be determined according to a preset value, and this is not limited herein.

In addition, if the actual rate of the service flow 1 processed by the UE A is increased from 1.5 Mbps to 2 Mbps, at least ⅓ (of a radio resource currently used by the UE A) needs to be added. According to a (proportional fairness scheduler (PSF) scheduling algorithm of a radio base station, a radio resource given up by the UE C whose actual rate is limited needs to be fairly allocated between the UE A and the UE B. The UE C needs to give up its ⅔ radio resource, and the target rate of the service flow 3 processed by the UE C is obtained according to the radio resource given up by the UE C, that is, the actual rate of the service flow 3 processed by the UE C is limited from original 3 Mbps to 1 Mbps. In this case, in the congestion relief policy determined by the PCRF, a maximum bit rate (MBR) of the service flow 3 processed by the UE C is set to 1 Mbps.

Step 103: The PCRF sends the congestion relief policy to a service flow pass-through node.

In step 103, the PCRF sends, using a Gx interface, the congestion relief policy to the PCEF or the service flow pass-through node, and the PCEF or the service flow pass-through node performs a congestion control according to the received congestion relief policy.

The PCEF may implement the congestion relief policy by executing a Random Early Detection (RED) algorithm in Active Queue Management (AQM) or a Token Bucket algorithm.

The PCRF receives the actual rates of the service flows processed by the multiple UEs, and when determining the congestion relief policy, the PCRF uses an actual rate of a service flow processed by each UE as a basis for quality of service QoS parameter quantization such that the determined congestion relief policy is a PCC policy set for one or more service flows of one or more UE, and congestion relief control accuracy is effectively increased.

The UE recorded in Table 2 are still used as an example. The PCEF or the service flow pass-through node performs a congestion control according to the received congestion relief policy, to obtain a predicted rate of a service flow processed by each UE, as shown in Table 3.

TABLE 3

| | Predicted rate |
|---|---|
| UE A Service flow 1 | 2 Mbps |
| UE B Service flow 2 | 2.6 Mbps |
| UE C Service flow 3 | 1 Mbps |

It should be noted that in addition to the PCEF, a network element device for executing the congestion relief policy may be an eNodeB, an AF, or a TDF, and an entity for executing the congestion relief policy is not limited herein.

The service flow pass-through node includes at least one or more of a PCEF, a TDF, or an eNodeB.

It should be noted that the foregoing PCRF is a logical PCRF, a quantity of physical PCRFs is not limited herein, and multiple PCRFs that complete a same function together are considered as a same logical PCRF.

It should be noted that the foregoing MME is a logical MME, a quantity of physical MMEs is not limited herein, and multiple MMEs that complete a same function together are considered as a same logical MME.

According to solutions in Embodiment 1 of the present application, a PCRF obtains actual rates of service flows processed by multiple UEs. The PCRF determines a congestion relief policy according to the obtained actual rates of the service flows processed by the multiple UEs. The congestion relief policy is used to limit an actual rate of a service flow processed by a UE in the multiple UEs. The PCRF sends the congestion relief policy to a service flow pass-through node such that the service flow pass-through node executes the congestion relief policy. In this embodiment of the present application, it is determined, according to obtained actual rates of service flows processed by different UE, that an actual rate of a service flow processed by a UE is limited in order to increase an actual rate of a service flow processed by another UE. This effectively relieves system congestion and improves user experience during congestion.

### Embodiment 2

As shown in FIG. 2, FIG. 2 is a schematic flowchart of a radio congestion control method according to Embodiment 2 of the present application. The method may be described as follows.

Step 201: A PCRF obtains actual rates of service flows processed by multiple UEs and channel qualities measured by the multiple UEs.

It should be noted that the channel quality herein may refer to an average value of channel quality indicators (CQI), or may refer to an average value of signal to noise ratios (SNR), and an indication form of the channel quality is not limited herein.

The PCRF obtains the channel qualities measured by the multiple UEs.

The PCRF receives RUCI sent by a RCAF or a service flow pass-through node, where the RUCI includes the channel qualities measured by the multiple UEs, and the PCRF obtains, from the received RUCI, the channel qualities measured by the multiple UEs.

It should be noted that a specific implementation manner of step 201 in Embodiment 2 of the present application is the same as an implementation manner of step 101 in Embodiment 1 of the present application, and details are not described herein again.

Step 202: The PCRF determines a congestion relief policy according to the obtained actual rates of the service flows processed by the multiple UEs, the obtained channel qualities measured by the multiple UEs, and obtained subscription information of the multiple UEs or obtained application layer information of the service flows processed by the multiple UEs.

The congestion relief policy is used to limit an actual rate of a service flow processed by a UE in the multiple UEs.

In step 202, to relieve system congestion, a radio resource needs to be coordinated between service flows processed by one or more UE, and an actual rate of a service flow is limited in order to increase an actual rate of another service flow.

The PCRF determines, according to the obtained actual rates of the service flows processed by the multiple UEs, the obtained channel qualities measured by the multiple UEs, and the obtained subscription information of the multiple UEs or the obtained application layer information of the service flows processed by the multiple UEs, the service flow whose actual rate is limited and a target rate of the limited service flow, and the PCRF determines the congestion relief policy according to the service flow whose actual rate is limited and the target rate of the limited service flow.

The target rate of the limited service flow includes a maximum bit rate of the limited service flow.

The congestion relief policy includes the service flow whose actual rate is limited and the target rate of the limited service flow.

The service flow whose actual rate is limited meets one or more of the following conditions. The actual rate of the service flow is greater than a specified expected rate, according to a subscriber class included in the obtained subscription information of the multiple UEs, the service flow whose actual rate is limited belongs to a service flow processed by a UE whose subscriber class is lower than a specified first threshold class, or according to a service processing class included in the obtained application layer information of the service flows processed by the multiple UEs, the service flow whose actual rate is limited belongs to a service flow whose service processing class is lower than a specified second threshold class.

The specified expected rate may be an expected rate or a maximum rate that is included in the application layer information and that is of the service flow, or may be a maximum rate that is included in the subscription information and that is allowed to be used by the UE, or may be determined according to another form. This is not limited herein.

The specified first threshold class and the specified second threshold class may be determined according to an actual requirement, or may be determined according to an actually processed service flow, and this is not limited herein either.

Subscription information of each UE or application layer information of a service flow processed by each UE may be obtained in real time by the PCRF from another network element of a PCC architecture and stored locally.

For example, the PCRF may obtain the subscription information of the UE from an SPR, and obtains, from an AF, the application layer information of the service flow processed by the UE.

A subscriber class of the UE is determined according to the obtained subscription information of the UE, and a service processing class, a minimum rate, and the like that are of the service flow processed by the UE are determined according to the obtained application layer information of the service flow.

It should be noted that a minimum rate of each service flow processed by each UE cannot always be determined from the obtained application layer information of the service flow, that is, it is possible that a minimum rate of a service flow cannot be determined.

The PCRF selects, according to the determined subscriber class of each UE, the minimum rate of each service flow, and the actual rate of the service flow processed by each UE, a service flow whose actual rate needs to be increased, and estimates a radio resource required for increasing the actual rate to the expected rate or the minimum rate.

The service flow whose actual rate needs to be increased includes at least one or more of the following service flows: a service flow whose actual rate is much less than the minimum rate, a service flow whose actual rate is much less than the minimum rate and that is processed by a UE whose subscriber class is higher than the specified first threshold class, or a service flow whose service processing class is higher than the specified second threshold class, whose actual rate is much less than the minimum rate, and that is processed by a UE whose subscriber class is higher than the specified first threshold class.

The PCRF selects, according to the determined subscriber class of each UE, the minimum rate of each service flow, and the actual rate of the service flow processed by each UE, the service flow whose actual rate needs to be limited, and calculates the target rate of the limited service flow according to the estimated required radio resource.

The service flow whose actual rate is limited meets one or more of the following conditions. The actual rate of the service flow is greater than a specified expected rate, according to a subscriber class included in the obtained subscription information of the multiple UEs, the service flow whose actual rate is limited belongs to a service flow processed by a UE whose subscriber class is lower than the specified first threshold class, or according to a service processing class included in the obtained application layer information of the service flows processed by the multiple UEs, the service flow whose actual rate is limited belongs to a service flow whose service processing class is lower than the specified second threshold class.

The radio resource required for increasing the actual rate of the service flow may be determined according to a channel quality measured by the UE corresponding to the service flow whose actual rate needs to be increased and according to a mapping relationship between a channel quality and a service flow rate. The target rate of the service flow whose actual rate is limited may be determined according to a channel quality measured by the UE corresponding to the service flow whose actual rate needs to be limited and according to a mapping relationship between a channel quality and a service flow rate.

Further, for the mapping relationship between a channel quality and a service flow rate, refer to Table 4. In Table 4, QPSK is quadrature phase-shift keying, and QAM is quadrature amplitude modulation.

TABLE 4

| Equivalent SNR | | Modulation | | |
|---|---|---|---|---|
| threshold | | (modulation | | |
| (BLER = 10%) | CQI | mode) | Code Rate | Bit Rate Mbps |
| −6.71 | 1 | QPSK | 0.08 | 0.95 |
| −5.11 | 2 | QPSK | 0.12 | 1.46 |
| −3.15 | 3 | QPSK | 0.19 | 2.35 |
| −0.87 | 4 | QPSK | 0.30 | 3.75 |
| 0.71 | 5 | QPSK | 0.44 | 5.47 |
| 2.529 | 6 | QPSK | 0.59 | 7.34 |
| 4.606 | 7 | 16-QAM | 0.37 | 9.21 |
| 6.431 | 8 | 16-QAM | 0.48 | 11.94 |
| 8.326 | 9 | 16-QAM | 0.60 | 15.02 |
| 10.3 | 10 | 64-QAM | 0.46 | 17.04 |
| 12.22 | 11 | 64-QAM | 0.55 | 20.73 |
| 14.01 | 12 | 64-QAM | 0.65 | 24.35 |
| 15.81 | 13 | 64-QAM | 0.75 | 28.23 |
| 17.68 | 14 | 64-QAM | 0.85 | 31.92 |
| 19.61 | 15 | 64-QAM | 0.93 | 34.66 |

It should be noted that data in the foregoing comparison table is empirical data in a 10-megahertz (MHz)-bandwidth LTE system, there is no uniform and standard data, and data varies with actual implementation situations of different types of base stations of various vendors.

For example, three service flows of three UE are included in RUCI, and specific information is shown in Table 5.

TABLE 5

| | CQI | Actual rate |
|---|---|---|
| UE A Service flow 1 | 4 | 1.5 Mbps |
| UE B Service flow 2 | 5.5 | 2 Mbps |
| UE C Service flow 3 | 7.5 | 3 Mbps |

According to subscription information of each UE, it is determined that a subscriber class of the UE A is higher than a subscriber class of the UE C, and the subscriber class of the UE A is higher than a subscriber class of the UE B.

According to application layer information of a service flow, an expected rate of the service flow 1 processed by the UE A is 3 Mbps, and the service flow 1 processed by the UE A may be considered in congestion and is the determined service flow whose actual rate needs to be increased.

According to application layer information of a service flow, both the actual rate of the service flow 2 processed by the UE B and the actual rate of the service flow 3 processed by the UE C are not limited, that is, both the service flow 2 processed by the UE B and the service flow 3 processed by the UE C may be considered as service flows that can be limited. Therefore, the PCRF determines to limit the actual rate of the service flow 2 processed by the UE B and the actual rate of the service flow 3 processed by the UE C in order to increase the actual rate of the service flow 1 processed by the UE A.

According to the mapping relationship between a channel quality and a service flow rate, the channel quality for the UE A, the actual rate of the service flow 1 processed by the UE A, the channel quality for the UE B, the actual rate of the service flow 2 processed by the UE B, the channel quality for the UE C, and the actual rate of the service flow 3 processed by the UE C, the PCRF estimates that a ratio of a radio resource occupied by the service flow 1 processed by the UE A to a sum of radio resources occupied by the service flow 2 processed by the UE B and occupied by the service flow 3 processed by the UE C is 4:6.

The PCRF determines to increase the actual rate of the service flow 1 processed by the UE A from 1.5 Mbps to 3 Mbps, and at least a double (of a radio resource currently occupied by the UE A) is required, that is, the ratio of the radio resource occupied by the UE A to the radio resources occupied by the UE B and the UE C is adjusted to 8:2 from the original 4:6. In this case, separately, the actual rate of the service flow 2 processed by the UE B needs to be limited to ⅓, that is, the actual rate of the service flow 2 processed by the UE B is limited to 0.66 Mbps, and the actual rate of the service flow 3 processed by the UE C needs to be limited to ⅓, that is, the actual rate of the service flow 3 processed by the UE C is limited to 1 Mbps.

In the congestion relief policy determined by the PCRF, an MBR of the service flow 2 processed by the UE B is set to 0.66 Mbps, and a maximum bit rate of the service flow 3 processed by the UE C is set to 1 Mbps.

Step 203: The PCRF sends the congestion relief policy to a service flow pass-through node.

In step 203, the PCRF sends, using a Gx interface, the congestion relief policy to a PCEF or the service flow pass-through node, and the PCEF or the service flow pass-through node performs a congestion control according to the received congestion relief policy.

According to channel quality information measured by each UE, an actual rate of a service flow processed by each UE, and a mapping relationship between a channel quality and a service flow transmission rate, the PCRF can estimate, in a relatively accurate way, a radio resource volume occupied by the service flow processed by each UE such that a target rate of a limited service flow can be accurately estimated, and effectiveness of the congestion relief policy is improved.

The method provided in this embodiment of the present application further effectively mitigates impact of unbalanced radio resource allocation among service flows because of different application layer characteristics of the service flows or different priorities (such as CQI) of the service flows.

It should be noted that in addition to the PCEF and an eNodeB, a network element device for executing the congestion relief policy may be an AF or a TDF, and an entity for executing the congestion relief policy is not limited herein.

The UE recorded in table 5 are still used as an example, and the PCEF or the service flow pass-through node performs a congestion control according to the received congestion relief policy, to obtain a predicted rate of a service flow processed by each UE, as shown in table 6.

TABLE 6

| | Predicted rate |
|---|---|
| UE A Service flow 1 | 3 Mbps |
| UE B Service flow 2 | 0.66 Mbps |
| UE C Service flow 3 | 1 Mbps |

It should be noted that in addition to the PCEF, a network element device for executing the congestion relief policy may be an eNodeB, an AF, or a TDF, and an entity for executing the congestion relief policy is not limited herein.

The service flow pass-through node includes at least one or more of a PCEF, a TDF, or an eNodeB.

It should be noted that the foregoing PCRF is a logical PCRF, a quantity of physical PCRFs is not limited herein, and multiple PCRFs that complete a same function together are considered as a same logical PCRF.

It should be noted that the foregoing MME is a logical MME, a quantity of physical MMEs is not limited herein, and multiple MMEs that complete a same function together are considered as a same logical MME.

In Embodiment 2 of the present application, it is determined, according to obtained actual rates of service flows processed by different UE, that an actual rate of a service flow processed by a UE is limited in order to increase an actual rate of a service flow processed by another UE. This effectively relieves system congestion and improves user experience during congestion.

### Embodiment 3

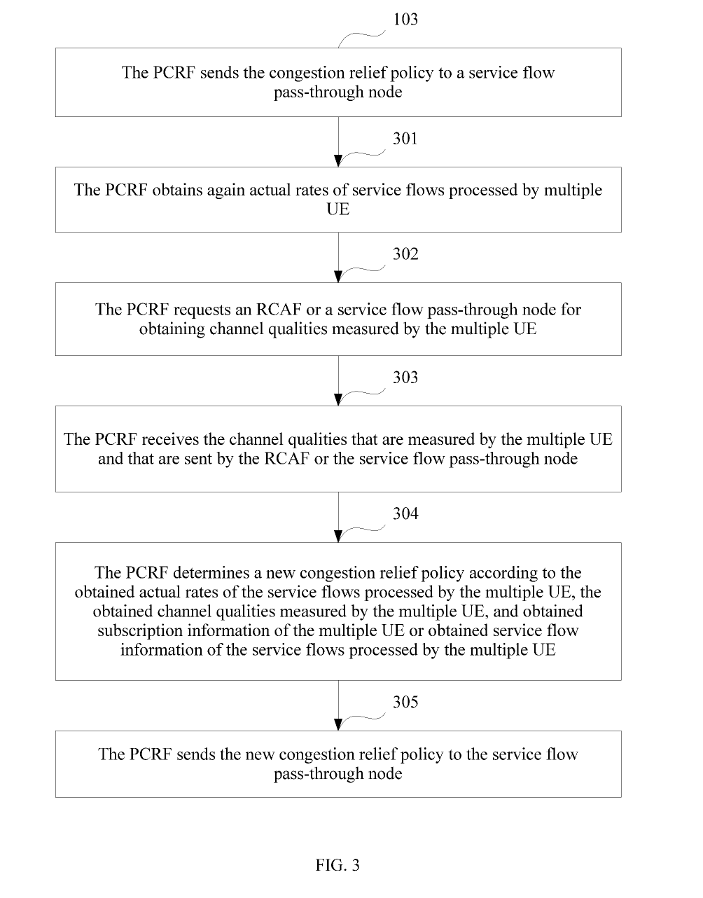

As shown in FIG. 3, FIG. 3 is a schematic flowchart of a radio congestion control method according to Embodiment 3 of the present application. The method may be described as follows.

Embodiment 3 of the present application provides further description on the basis of Embodiment 1 of the present application.

In step 103 of Embodiment 1 of the present application, the PCRF sends the congestion relief policy to the service flow pass-through node.

In step 103, the PCRF sends, using a Gx interface, the congestion relief policy to the PCEF or the service flow pass-through node, and the PCEF or the service flow pass-through node performs a congestion control according to the received congestion relief policy.

Step 301: The PCRF obtains again actual rates of service flows processed by multiple UEs.

The actual rates of the service flows processed by the multiple UEs are reported after the congestion relief policy is sent by the PCRF in step 103, an obtaining manner is the same as that in step 101, and details are not described herein again.

Step 302: The PCRF requests an RCAF or a service flow pass-through node for obtaining channel qualities measured by the multiple UEs.

Step 303: The PCRF receives the channel qualities that are measured by the multiple UEs and that are sent by the RCAF or the service flow pass-through node.

It should be noted that when the RCAF or the service flow pass-through node sends a channel quality measured by each UE, a UE identifier is further included, for example, a first UE (a UE 1), and a channel quality 1.

Alternatively, the channel qualities may be sent together with the actual rates that are of the service flows processed by the multiple UEs and that are obtained in step 101, as shown in Table 7.

TABLE 7

| | Chanel | Service flow | Service flow | | Service flow |
|---|---|---|---|---|---|
| | quality | identifier 1 | identifier 2 | . . . | identifier n |
| UE 1 | Chanel | Actual rate 11 | Actual rate 12 | . . . | Actual rate n1 |
| | quality 1 | | | | |
| UE 2 | Chanel | Actual rate 21 | Actual rate 22 | . . . | Actual rate n2 |
| | quality 2 | | | | |
| . . . | . . . | . . . | . . . | . . . | |
| UE N | Chanel | Actual rate n1 | Actual rate n2 | . . . | Actual rate nn |
| | quality n | | | | |

It should be noted that the channel quality herein may refer to an average value of CQIs, or may refer to an average value of SNR, and an indication form of the channel quality is not limited herein.

Step 304: The PCRF determines a new congestion relief policy according to the obtained actual rates of the service flows processed by the multiple UEs, the obtained channel qualities measured by the multiple UEs, and obtained subscription information of the multiple UEs or obtained application layer information of the service flows processed by the multiple UEs.

The new congestion relief policy is used to limit an actual rate of a service flow processed by a UE in the multiple UEs.

In step 304, a manner for determining the new congestion relief policy is as described in step 202 of Embodiment 2, and details are not described herein again.

Step 305: The PCRF sends the new congestion relief policy to the service flow pass-through node.

In step 305, the PCRF sends the new congestion relief policy to the PCEF using the Gx interface, and the PCEF performs a radio congestion control using the received new congestion relief policy.

The service flow pass-through node includes at least one or more of a PCEF, a TDF, or an eNodeB.

It should be noted that in addition to the PCEF and the eNodeB, a network element device for executing the congestion relief policy may be an AF or a TDF, and an entity for executing the congestion relief policy is not limited herein.

In Embodiment 3 of the present application, according to actual rates that are of service flows processed by multiple UEs and that are received for the second time, a PCRF adjusts a congestion relief policy delivered for the first time, and determines a new congestion relief policy according to received channel qualities measured by the multiple UEs, thereby effectively increasing congestion control accuracy.

It should be noted that channel quality information for each UE may be requested and obtained after congestion information is received again or at another moment. The information may be requested by the PCRF, or may be actively reported by an RCAF or a service flow pass-through node, and this is not limited herein.

It should be noted that the channel quality information of each UE may not only be obtained from an RCAF, but also be directly obtained by the PCRF from an RAN OAM or an RAN side node, such as an eNodeB.

### Embodiment 4

As shown in FIG. 4, FIG. 4 is a schematic flowchart of a radio congestion control method according to Embodiment 4 of the present application. Embodiment 4 of the present application is executed by a service flow pass-through node. The method may be described as follows.

Step 401: The service flow pass-through node sends actual rates of service flows processed by multiple UEs to a PCRF.

Step 401 that the service flow pass-through node sends actual rates of service flows processed by multiple UEs to a PCRF includes sending, by the service flow pass-through node, RUCI to the PCRF, where the RUCI includes the actual rates of the service flows processed by the multiple UEs.

Optionally, that the service flow pass-through node sends actual rates of service flows processed by multiple UEs to a PCRF includes collecting, by the service flow pass-through node, statistics on actual rates of the service flows processed by the multiple UEs within a specified time length, and calculating an average rate of a service flow processed by each UE within the specified time length, and triggering the service flow pass-through node to send the actual rates of the service flows processed by the multiple UEs to the PCRF when a calculated average rate of at least one service flow is less than a specified rate threshold.

Step 402: The service flow pass-through node receives a congestion relief policy sent by the PCRF.

The congestion relief policy is determined by the PCRF according to the actual rates of the service flows processed by the multiple UEs, and the congestion relief policy is used to limit an actual rate a service flow of a UE in the multiple UEs.

Step 403: The service flow pass-through node controls current congestion according to the received congestion relief policy.

In step 403, the congestion relief policy includes the service flow whose actual rate is limited and a target rate of the service flow whose actual rate is limited.

For the UE processing the service flow whose actual rate is limited, the service flow pass-through node reduces, according to the target rate that is of the service flow whose actual rate is limited and that is included in the congestion relief policy, the actual rate of the limited service flow processed by the UE.

The service flow pass-through node includes at least one or more of a PCEF, a TDF, or an eNodeB.

### Embodiment 5

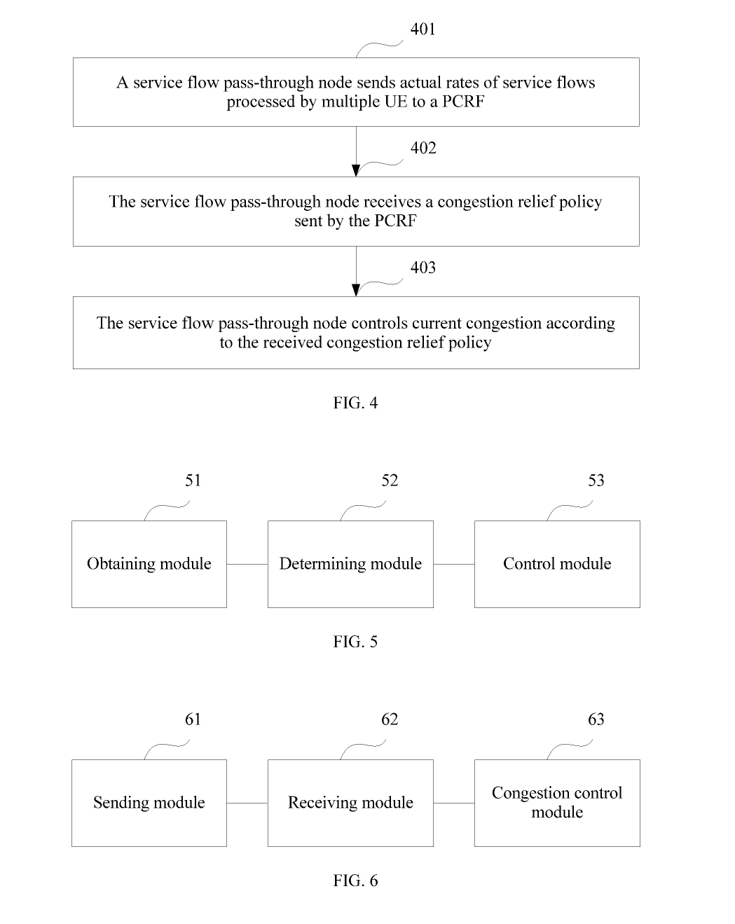

As shown in FIG. 5, FIG. 5 is a schematic structural diagram of a radio congestion control device according to Embodiment 5 of the present application. The radio congestion control device includes an obtaining module 51, a determining module 52, and a control module 53.

The obtaining module 51 is configured to obtain actual rates of service flows processed by multiple UEs.

The determining module 52 is configured to determine a congestion relief policy according to the actual rates that are of the service flows processed by the multiple UEs and that are obtained by the obtaining module 51, where the congestion relief policy is used to limit an actual rate of a service flow processed by a UE in the multiple UEs.

The control module 53 is configured to send the congestion relief policy determined by the determining module 52 to a service flow pass-through node.

The obtaining module 51 is further configured to obtain subscription information of the multiple UEs, or obtain service flow information of the service flows processed by the multiple UEs.

The determining module 52 is configured to determine, according to the obtained actual rates of the service flows processed by the multiple UEs and the obtained subscription information of the multiple UEs or obtained application layer information of the service flows processed by the multiple UEs, the service flow whose actual rate is limited and a target rate of the limited service flow, and determine the congestion relief policy according to the service flow whose actual rate is limited and the target rate of the limited service flow.

The target rate of the limited service flow includes a maximum bit rate of the limited service flow.

The obtaining module 51 is further configured to obtain channel qualities measured by the multiple UEs.

The determining module 52 is configured to determine, according to the obtained actual rates of the service flows processed by the multiple UEs, the obtained channel qualities measured by the multiple UEs, and the obtained subscription information of the multiple UEs or the obtained application layer information of the service flows processed by the multiple UEs, the service flow whose actual rate is limited and the target rate of the limited service flow, and determine the congestion relief policy according to the service flow whose actual rate is limited and the target rate of the limited service flow.

The service flow whose actual rate is limited meets one or more of the following conditions. The actual rate of the service flow is greater than a specified expected rate, according to a subscriber class included in the obtained subscription information of the multiple UEs, the service flow whose actual rate is limited belongs to a service flow processed by a UE whose subscriber class is lower than a specified first threshold class, or according to a service processing class included in the obtained application layer information of the service flows processed by the multiple UEs, the service flow whose actual rate is limited belongs to a service flow whose service processing class is lower than a specified second threshold class.

The obtaining module 51 is configured to receive RUCI sent by an RCAF or the service flow pass-through node, where the RUCI includes the actual rates of the service flows processed by the multiple UEs, and obtain, from the received RUCI, the actual rates of the service flows processed by the multiple UEs.

Further, the service flow pass-through node includes at least one or more of a PCEF, a TDF, or an eNodeB.

The radio congestion control device provided in Embodiment 5 of the present application may be a logical component integrated in the PCRF, or may be a device independent of the PCRF, and may be implemented in a hardware manner, or may be implemented in a software manner.

### Embodiment 6

As shown in FIG. 6, FIG. 6 is a schematic structural diagram of a radio congestion control device according to Embodiment 6 of the present application. The device includes a sending module 61, a receiving module 62, and a congestion control module 63.

The sending module 61 is configured to send actual rates of service flows processed by multiple UEs to a PCRF.

The receiving module 62 is configured to receive a congestion relief policy sent by the PCRF, where the congestion relief policy is determined by the PCRF according to the actual rates of the service flows processed by the multiple UEs, and the congestion relief policy is used to limit an actual rate of a service flow of a UE in the multiple UEs.

The congestion control module 63 is configured to control current congestion according to the received congestion relief policy.

Further, the sending module 61 is configured to send RUCI to the PCRF, where the RUCI includes the actual rates of the service flows processed by the multiple UEs.

The sending module 61 is configured to collect statistics on actual rates of the service flows processed by the multiple UEs within a specified time length, and calculate an average rate of a service flow processed by each UE within the specified time length, and triggered to send the actual rates of the service flows processed by the multiple UEs to the PCRF when a calculated average rate of at least one service flow is less than a specified rate threshold.

Optionally, the congestion relief policy includes the service flow whose actual rate is limited and a target rate of the service flow whose actual rate is limited.

The congestion control module 63 is configured to reduce for the UE processing the service flow whose actual rate is limited, according to the target rate that is of the service flow whose actual rate is limited and that is included in the congestion relief policy, the actual rate of the limited service flow processed by the UE.

The radio congestion control device provided in Embodiment 6 of the present application may be a logical component integrated in a service flow pass-through node, or may be a device independent of a service flow pass-through node, and may be implemented in a hardware manner, or may be implemented in a software manner.

The service flow pass-through node includes at least one or more of a PCEF, a TDF, or an eNodeB.

### Embodiment 7

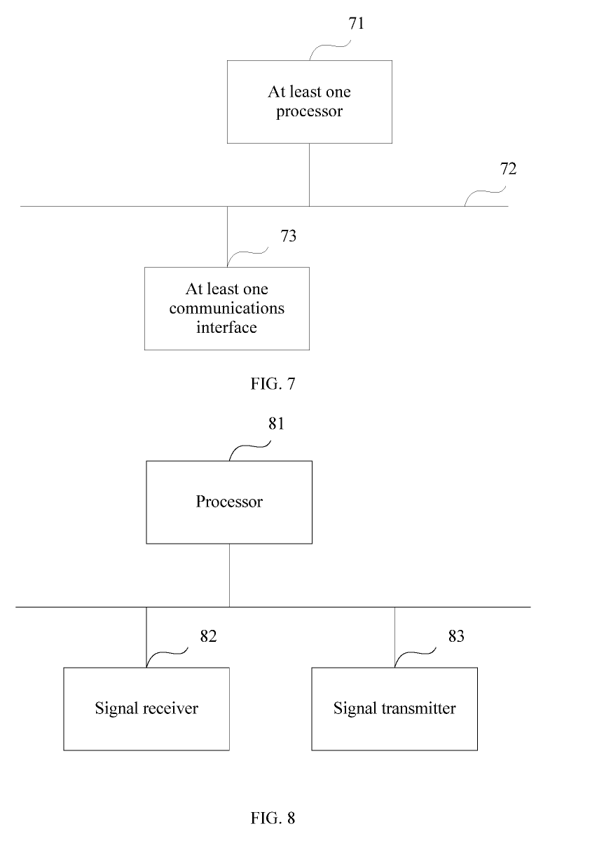

As shown in FIG. 7, FIG. 7 is a schematic structural diagram of a radio congestion control device according to Embodiment 7 of the present application. The radio congestion control device has a function of executing Embodiment 1 to Embodiment 4 of the present application. The radio congestion control device may use a general computer system structure, and the computer system structure may be a processor-based computer. The radio congestion control device entity includes at least one processor 71, a communications bus 72, and at least one communications interface 73. The at least one processor 71 and the at least one communications interface 73 communicate using the communications bus 72.

The at least one communications interface 73 is configured to obtain actual rates of service flows processed by multiple UEs.

The at least one processor 71 is configured to determine a congestion relief policy according to the obtained actual rates of the service flows processed by the multiple UsE. The congestion relief policy is used to limit an actual rate of a service flow processed by a UE in the multiple UEs.

The at least one communications interface 73 is further configured to send the congestion relief policy to a service flow pass-through node.

The at least one communications interface 73 is further configured to obtain subscription information of the multiple UEs, or obtain service flow information of the service flows processed by the multiple UEs.

The at least one processor 71 is configured to determine, according to the obtained actual rates of the service flows processed by the multiple UEs and the obtained subscription information of the multiple UEs or obtained application layer information of the service flows processed by the multiple UEs, the service flow whose actual rate is limited and a target rate of the limited service flow, and determine the congestion relief policy according to the service flow whose actual rate is limited and the target rate of the limited service flow.

The target rate of the limited service flow includes a maximum bit rate of the limited service flow.

The at least one communications interface 73 is further configured to obtain channel qualities measured by the multiple UEs.

The at least one processor 71 is configured to determine, according to the obtained actual rates of the service flows processed by the multiple UEs, the obtained channel qualities measured by the multiple UEs, and the obtained subscription information of the multiple UEs or the obtained application layer information of the service flows processed by the multiple UEs, the service flow whose actual rate is limited and the target rate of the limited service flow, and determine the congestion relief policy according to the service flow whose actual rate is limited and the target rate of the limited service flow.

The service flow whose actual rate is limited meets one or more of the following conditions. The actual rate of the service flow is greater than a specified expected rate, according to a subscriber class included in the obtained subscription information of the multiple UEs, the service flow whose actual rate is limited belongs to a service flow processed by a UE whose subscriber class is lower than a specified first threshold class, or according to a service processing class included in the obtained application layer information of the service flows processed by the multiple UEs, the service flow whose actual rate is limited belongs to a service flow whose service processing class is lower than a specified second threshold class.

The at least one communications interface 73 is configured to receive RUCI sent by an RCAF or the service flow pass-through node, where the RUCI includes the actual rates of the service flows processed by the multiple UEs, and obtain, from the received RUCI, the actual rates of the service flows processed by the multiple UEs.

The service flow pass-through node includes at least one or more of a PCEF, a TDF, or an eNodeB.

The processor 71 may be a general-purpose central processing unit (CPU), a microprocessor, an application-specific integrated circuit (ASIC), or one or more integrated circuits used to control execution of programs of the solutions in the present application.

The communications bus 72 may include a path in which information is transmitted between the foregoing components. The communications interface 73, using any apparatus such as a transceiver, is configured to communicate with another device or a communications network, such as Ethernet, a RAN, or a wireless local area network (WLAN).

### Embodiment 8

As shown in FIG. 8, FIG. 8 is a schematic structural diagram of a radio congestion control device according to Embodiment 8 of the present application. The radio congestion control device has a function of executing Embodiment 1 to Embodiment 4 of the present application. The radio congestion control device may use a general computer system structure, and the computer system structure may be a processor-based computer. The radio congestion control device entity includes a processor 81, a signal receiver 82, and a signal transmitter 83.

The signal transmitter 83 is configured to send actual rates of service flows processed by multiple UEs to a PCRF.

The signal receiver 82 is configured to receive a congestion relief policy sent by the PCRF, where the congestion relief policy is determined by the PCRF according to the actual rates of the service flows processed by the multiple UEs, and the congestion relief policy is used to limit an actual rate of a service flow of a UE in the multiple UEs.

The processor 81 is configured to control current congestion according to the received congestion relief policy.

The signal transmitter 83 is configured to send RUCI to the PCRF, where the RUCI includes the actual rates of the service flows processed by the multiple UEs.

The signal transmitter 83 is configured to collect statistics on actual rates of the service flows processed by the multiple UEs within a specified time length, and calculate an average rate of a service flow processed by each UE within the specified time length, and send the actual rates of the service flows processed by the multiple UEs to the PCRF when a calculated average rate of at least one service flow is less than a specified rate threshold.

The congestion relief policy includes the service flow whose actual rate is limited and a target rate of the service flow whose actual rate is limited.

The processor 81 is configured to reduce, for the UE processing the service flow whose actual rate is limited, according to the target rate that is of the service flow whose actual rate is limited and that is included in the congestion relief policy, the actual rate of the limited service flow processed by the UE.

The processor 81 may be a general-purpose CPU, a microprocessor, an ASIC, or one or more integrated circuits used to control execution of programs of the solutions in the present application.

A person skilled in the art should understand that the embodiments of the present application may be provided as a method, an apparatus (device), or a computer program product. Therefore, the present application may use a form of hardware only embodiments, software only embodiments, or embodiments with a combination of software and hardware. Moreover, the present application may use a form of a computer program product that is implemented on one or more computer-usable storage media (including but not limited to a disk memory, a compact-disc read-only memory (CD-ROM), an optical memory, and the like) that include computer-usable program code.

The present application is described with reference to the flowcharts or block diagrams of the method, the apparatus (device), and the computer program product according to the embodiments of the present application. It should be understood that computer program instructions may be used to implement each process or each block in the flowcharts or the block diagrams and a combination of a process or a block in the flowcharts or the block diagrams. These computer program instructions may be provided for a general-purpose computer, a dedicated computer, an embedded processor, or a processor of any other programmable data processing device to generate a machine such that the instructions executed by a computer or a processor of any other programmable data processing device generate an apparatus for implementing a specific function in one or more processes in the flowcharts or in one or more blocks in the block diagrams.

These computer program instructions may also be stored in a computer readable memory that can instruct the computer or any other programmable data processing device to work in a specific manner such that the instructions stored in the computer readable memory generate an artifact that includes an instruction apparatus. The instruction apparatus implements a specific function in one or more processes in the flowcharts or in one or more blocks in the block diagrams.

These computer program instructions may also be loaded onto a computer or another programmable data processing device such that a series of operations and steps are performed on the computer or the other programmable device, thereby generating computer-implemented processing. Therefore, the instructions executed on the computer or the other programmable device provide steps for implementing a specific function in one or more processes in the flowcharts or in one or more blocks in the block diagrams.

Obviously, a person skilled in the art can make various modifications and variations to the present application without departing from the spirit and scope of the present application. The present application is intended to cover these modifications and variations provided that they fall within the scope of protection defined by the following claims and their equivalent technologies.

What is claimed is:

1. A radio congestion control method implemented in a policy and charging rules function (PRCF), the method comprising:
obtaining actual rates of service flows processed by user equipments (UEs);
determining a congestion relief policy according to the actual rates, wherein the congestion relief policy limits the actual rates; and
sending the congestion relief policy to a service flow pass-through node.

2. The method of claim 1, further comprising obtaining subscription information of the UEs or obtaining service flow information of the service flows, wherein determining the congestion relief policy comprises:
determining, according to the actual rates and the subscription information or the service flow information, a first service flow whose first actual rate is limited and a target rate of the first service flow; and
determining the congestion relief policy according to the first service flow and the target rate,
wherein the target rate comprises a maximum bit rate of the first service flow.

3. The method of claim 2, further comprising obtaining channel qualities measured by the UEs, wherein determining the congestion relief policy comprises:
determining, according to the actual rates, the channel qualities, and the subscription information or the service flow information, the first service flow and the target rate; and
determining the congestion relief policy according to the first service flow and the target rate.

4. The method of claim 2, wherein the first service flow meets at least one of the following conditions:
the first actual rate is greater than an expected rate;
the first service flow is processed by a first UE whose subscriber class is lower than a first threshold class and is in the subscription information; and
a service processing class of the first service flow and in the service flow information is lower than a specified second threshold class.

5. The method of claim 1, wherein obtaining the actual rates comprises:
receiving radio access network user plane congestion information (RUCI) from a radio congestion awareness function (RCAF) or the service flow pass-through node, wherein the RUCI comprises the actual rates; and
obtaining the actual rates from the RUCI.

6. The method of claim 5, wherein the service flow pass-through node comprises at least one of a policy and charging enforcement function (PCEF), a traffic detection function (TDF), and an evolved NodeB (eNodeB).

7. A radio congestion control method implemented by a service flow pass-through node, the method comprising:
sending to a policy and charging rules function (PCRF) actual rates of service flows processed by user equipments (UEs);
receiving from the PCRF a congestion relief policy determined according to the actual rates, wherein the congestion relief policy limits the actual rates; and
controlling current congestion according to the congestion relief policy.

8. The method of claim 7, wherein sending the actual rates comprises sending to the PCRF radio access network user plane congestion information (RUCI) comprising the actual rates.

9. The method of claim 7, wherein sending the actual rates comprises:
collecting statistics on the actual rates within a time length;
calculating an average rate of each service flow within the time length; and
triggering the service flow pass-through node to send the actual rates to the PCRF when at least one average rate is less than a rate threshold.

10. The method of claim 7, wherein the congestion relief policy comprises a first service flow whose first actual rate is limited and a first target rate of the first service flow, and wherein controlling the current congestion comprises reducing, for a first UE processing the first service flow and according to the first target rate, the first actual rate.

11. A radio congestion control device comprising:
a memory;
a processor coupled to the memory and configured to:
obtain actual rates of service flows processed by user equipments (UEs); and
determine a congestion relief policy according to the actual rates, wherein the congestion relief policy limits the actual rates; and
a transmitter coupled to the processor and configured to send the congestion relief policy to a service flow pass-through node.

12. The device of claim 11, wherein the processor is further configured to:
obtain subscription information of the UEs or obtain service flow information of the service flows;
determine, according to the actual rates and the subscription information or the service flow information, a first service flow whose first actual rate is limited and a target rate of the first service flow; and
determine the congestion relief policy according to the first service flow and the target rate,
wherein the target rate comprises a maximum bit rate of the first service flow.

13. The device of claim 12, wherein the processor is further configured to:
obtain channel qualities measured by the UEs;
determine, according to the actual rates, the channel qualities, and the subscription information or the service flow information, the first service flow; and
determine the congestion relief policy according to the first service flow and the target rate.

14. The device of claim 11, wherein the first service flow meets at least one of the following conditions:
the first actual rate is greater than an expected rate;
the first service flow is processed by a first UE whose subscriber class is lower than a first threshold class and is in the subscription information; and
a service processing class of the first service flow and in the service flow information is lower than a specified second threshold class.

15. The device of claim 11, further comprising a receiver coupled to the processor and configured to receive radio access network user plane congestion information (RUCI) from a radio congestion awareness function (RCAF) or the service flow pass-through node, wherein the RUCI comprises the actual rates, wherein the processor is further configured to obtain the actual rates from the RUCI.

16. The device of claim 15, wherein the service flow pass-through node comprises at least one of a policy and charging enforcement function (PCEF), a traffic detection function (TDF), and an evolved NodeB (eNodeB).

17. A radio congestion control device comprising:
a transmitter configured to send to a policy and charging rules function (PCRF) actual rates of service flows processed by user equipments (UEs);
a receiver configured to receive from the PCRF a congestion relief policy determined according to the actual rates, wherein the congestion relief policy limits the actual rates; and
a processor coupled to the transmitter and the receiver and configured to control current congestion according to the congestion relief policy.

18. The device of claim 17, wherein the transmitter is further configured to send to the PCRF radio access network user plane congestion information (RUCI) comprising the actual rates.

19. The device of claim 17, wherein the processor is further configured to:
collect statistics on the actual rates within a time length;
calculate an average rate of each service flow within the time length; and
trigger the transmitter to send the actual rates to the PCRF when at least one average rate is less than a rate threshold.

20. The device according to claim 17, wherein the congestion relief policy comprises a first service flow whose first actual rate is limited and a first target rate of the first service flow, and wherein the processor is further configured to reduce, for a first UE processing the first service flow and according to the first target rate, the first actual rate.
